(19) United States
(12) Patent Application Publication
(10) Pub. No.: US 2016/0210735 A1
(43) Pub. Date: Jul. 21, 2016

(54) SYSTEM FOR OBSTACLE AVOIDANCE AROUND A MOVING OBJECT

(71) Applicant: KABUSHIKI KAISHA TOSHIBA, Tokyo (JP)

(72) Inventor: Tomonori FUKUSHIMA, Kawasaki Kanagawa (JP)

(21) Appl. No.: 14/842,442

(22) Filed: Sep. 1, 2015

(30) Foreign Application Priority Data
Jan. 21, 2015 (JP) 2015-009750

(51) Int. Cl. G06T 7/00; G06K 9/00; B60R 1/00; H04N 7/18

(52) U.S. Cl. CPC G06T 7/004; H04N 7/183; G06K 9/00805; B60R 1/00; G06T 2207/30261

(57) ABSTRACT

A system for recognizing obstacle avoidance around a moving object includes an image capturing unit configured to capture images in a moving direction of the object, a processing unit configured to generate three-dimensional data based on the captured images, determine positions of the obstacles in a three-dimensional space according to the three-dimensional data, and generate an image including marks indicating a region proximate to the obstacles, and a display unit configured to display the generated image.

### CROSS-REFERENCE TO RELATED APPLICATION

This application is based upon and claims the benefit of priority from Japanese Patent Application No. 2015-009750, filed Jan. 21, 2015, the entire contents of which are incorporated herein by reference.

### FIELD

Embodiments described herein relate generally to a system for obstacle avoidance around a moving object.

### BACKGROUND

For moving objects such as a vehicle, a radio-controlled model car, and a plane, a technique for accurately calculating distance between obstacles and a moving object to prevent collision therewith would be desirable. For example, a drive assist system for a vehicle visually assists a driver to determine whether the vehicle may pass a road by displaying the vehicle in a virtual manner on a head up display or the like.

### DESCRIPTION OF THE DRAWINGS

FIG. 1 illustrates a configuration of an image processing apparatus according to a first embodiment.

FIG. 2 schematically illustrates a vehicle in which the image processing apparatus according to the first embodiment is mounted.

FIG. 3 is a flowchart of image processing carried out by the image processing apparatus according to the first embodiment.

FIG. 4A illustrates a ground surface arbitrarily located; and FIG. 4B illustrates a ground surface parallel to an image capturing angle.

FIG. 5 is a flowchart of processing to identify a ground surface using RANSAC (random sample consensus) according to the first embodiment.

FIG. 6 illustrates planes extracted using the RANSAC according to the first embodiment.

FIG. 7 is a flowchart of processing to extract obstacles according to the first embodiment.

FIG. 8 is a block diagram of a plane coincidence calculation processing unit in an image processing unit of the image processing apparatus according to the first embodiment.

FIG. 9 is a block diagram of an arithmetic unit of the plane coincidence calculation processing unit according to the first embodiment.

FIG. 10 is a flowchart of processing to calculate distance to obstacles according to the first embodiment.

FIG. 11 is a block diagram of a shortest-distance calculation processing unit in an image processing unit of the image processing apparatus according to the first embodiment.

FIG. 12 is a block diagram of an arithmetic unit of the shortest-distance calculation processing unit according to the first embodiment.

FIG. 13 illustrates an example of an obstacle distance map according to the first embodiment.

FIG. 14 is an isoline map generated based on the obstacle distance map.

FIG. 15 illustrates a three-dimensional space in which obstacles are located.

FIG. 16 is a three-dimensional view of the obstacles.

FIG. 17 illustrates an example of the visualized obstacle distance map according to the first embodiment.

FIG. 18 is a combined image of the obstacles and the visualized obstacle distance map.

FIG. 19 is the combined image viewed from a portion right above.

FIG. 20 illustrates a passable route and an impassable route in the three-dimensional space according to the first embodiment.

FIG. 21 illustrates the passable route and the impassable route viewed from a portion right above.

FIG. 22 illustrates a configuration of an image processing apparatus according to a second embodiment.

FIG. 23 is a flowchart of image processing carried out by the image processing apparatus according to the second embodiment.

FIG. 24 illustrates a configuration of an image processing apparatus according to a third embodiment.

FIG. 25 is a flowchart of image processing carried out by the image processing apparatus according to the third embodiment.

### DETAILED DESCRIPTION

In general, according to an embodiment, a system for obstacle avoidance around a moving object includes an image capturing unit configured to capture images in a moving direction of the object, a processing unit configured to generate three-dimensional data based on the captured images, determine positions of the obstacles in a three-dimensional space according to the three-dimensional data, and generate an image including marks indicating a region proximate to the obstacles, and a display unit configured to display the generated image.

Hereinafter, the embodiments herein will be described with reference to the drawings.

### First Embodiment

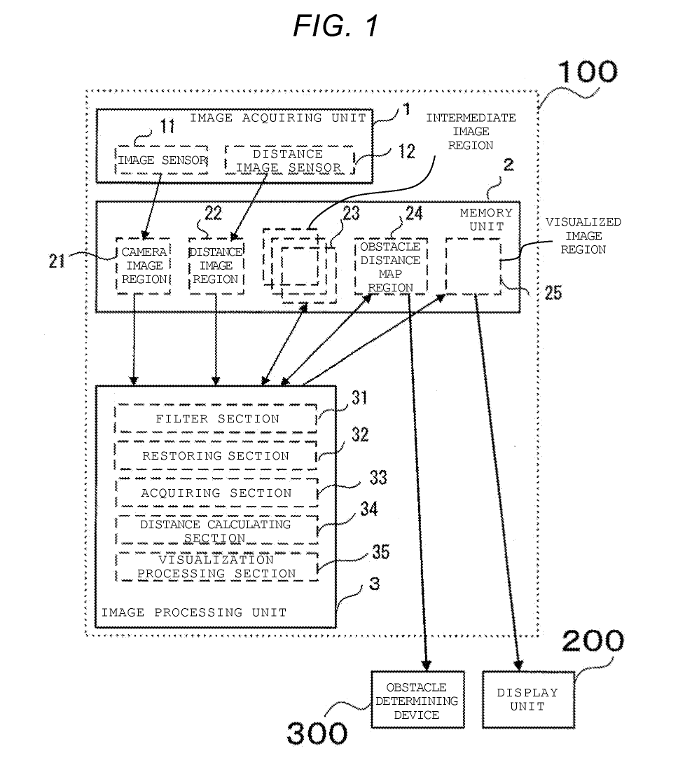

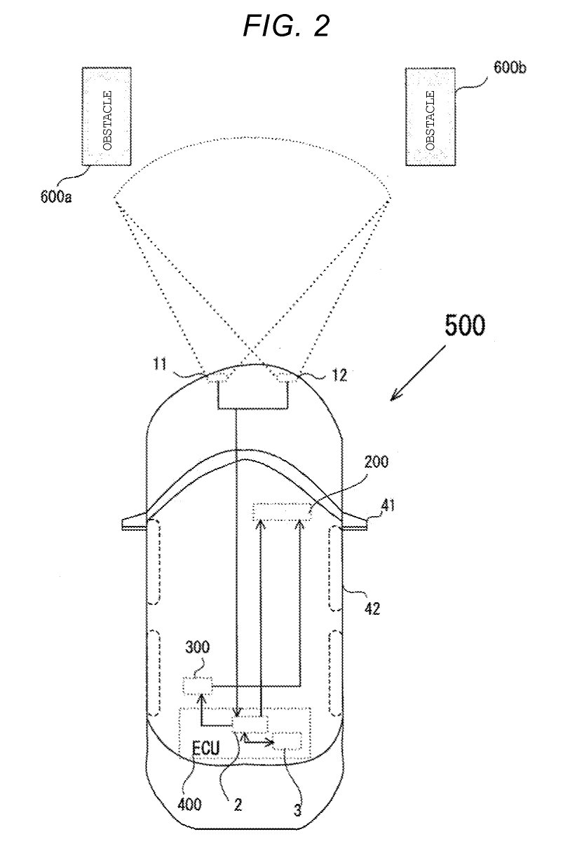

First, an image processing apparatus and a drive assist system using the same according to the first embodiment will be described with reference to the drawings. FIG. 1 illustrates a configuration of the image processing apparatus. FIG. 2 schematically illustrates a vehicle in which the image processing apparatus is mounted.

In the present embodiment, a contact of the vehicle with an obstacle will be predicted in advance using an image processing apparatus.

As illustrated in FIG. 1, an image processing apparatus 100 includes an image acquiring unit 1, a memory unit 2, and an image processing unit 3. The image processing apparatus 100 is able to measure the distance to an obstacle with high accuracy and predict contact of the vehicle with the obstacle in advance. The details will be described in the following.

An image visualized in the image processing apparatus 100 is displayed on the display unit 200. Obstacle distance map information output from the image processing apparatus 100 is input to an obstacle determining unit 300. The obstacle determining unit 300 determines the possibility of a vehicle's contacting an obstacle in advance.

The image acquiring unit 1 includes an image sensor 11 and a distance image sensor 12. The image sensor 11 outputs image data of a surrounding image including obstacles. For example, the image sensor 11 includes a camera that detects light in a visible wavelength range to capture a daytime image, a night vision camera that detects light (ray) in a near infrared range or a far-infrared range to capture a night image, and the like. The distance image sensor 12 acquires information relating to a distance to an obstacle. The distance image sensor 12 includes, for example, a time-of-flight (TOF) camera that is usable both day and night, a plurality of stereo cameras that is usable both day and night, or the like.

The memory unit 2 includes an image information region 21, a distance information region 22, an intermediate image region 23, an obstacle distance map region 24, and a visualized image region 25.

The image information region 21 stores image information acquired by the image sensor 11. The distance information region 22 stores distance information acquired by the distance image sensor 12. The intermediate image region 23 stores intermediate images acquired through image processing performed by the image processing apparatus 100. The obstacle distance map region 24 stores obstacle distance map information calculated by the image processing unit 3. The visualized image region 25 stores visualized image information calculated by the image processing unit 3.

The image processing unit 3 includes a filter section 31, a restoring section 32, an acquiring module 33, a distance calculating section 34, and a visualization processing section 35.

The filter section 31 removes noises of the image information and the distance information output from the image information region 21, the distance information region 22, and the intermediate image region 23. The restoring section 32 restores three-dimensional information from the acquired image information and the distance information. The acquiring section 33, for example, extracts data corresponding to the ground surface from the restored three-dimensional information and extracts the remaining data as obstacle data. The distance calculating section 34 calculates the shortest distance to an obstacle. The visualization processing section 35 visualizes the position between obstacles and the positional relationship between the vehicle and the obstacle.

As illustrated in FIG. 2, a driver (not illustrated) gets in a vehicle 500 and drives the vehicle 500. The vehicle 500 includes the image sensor 11, the distance image sensor 12, a mirror 41, a door 42, a display unit 200, the obstacle determining unit 300, and an ECU (engine control unit) 400.

The vehicle 500 includes a drive assist system that predicts contact with an obstacle in advance. The drive assist system, for example, includes the memory unit 2, the image processing unit 3, the image sensor 11, the distance image sensor 12, the display unit 200, and the obstacle determining unit 300.

The image sensor 11 is disposed at the left-front portion of the vehicle 500 and acquires image information that includes obstacles 600a and 600b. The distance image sensor 12 is disposed at the right-front portion of the vehicle 500 and acquires distance information indicating a distance to an obstacle. The ECU 400 is disposed at the rear portion of the vehicle 500 and includes the memory unit 2 and the image processing unit 3. The obstacle determining unit 300 is disposed in the vicinity of a door 42 at the left-rear portion and inputs the obstacle distance map information stored in the memory unit 2.

The display unit 200 is provided in the vicinity of the mirror 41 on the right side and displays the visualized image information stored in the memory unit 2. The display unit 200 also displays the information of the possibility of a contact with an obstacle, which is output from the obstacle determining unit 300. For the display unit 200, a head-up display (HUD), a monitor inside a vehicle, or the like is used.

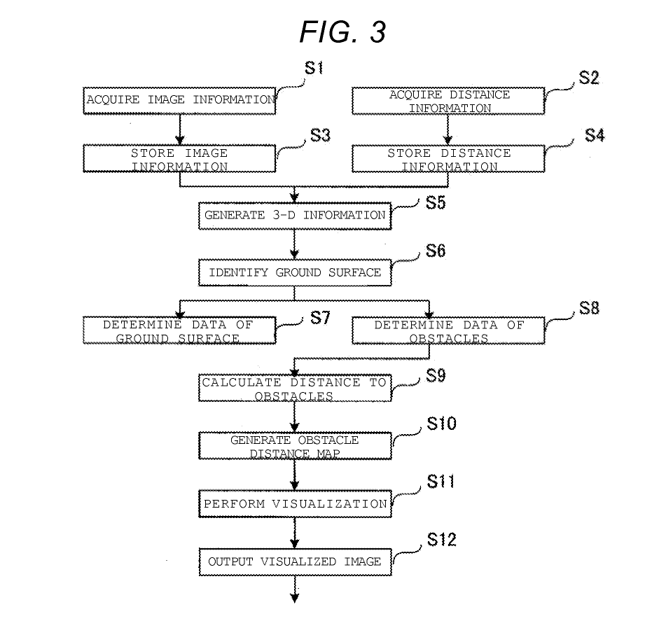

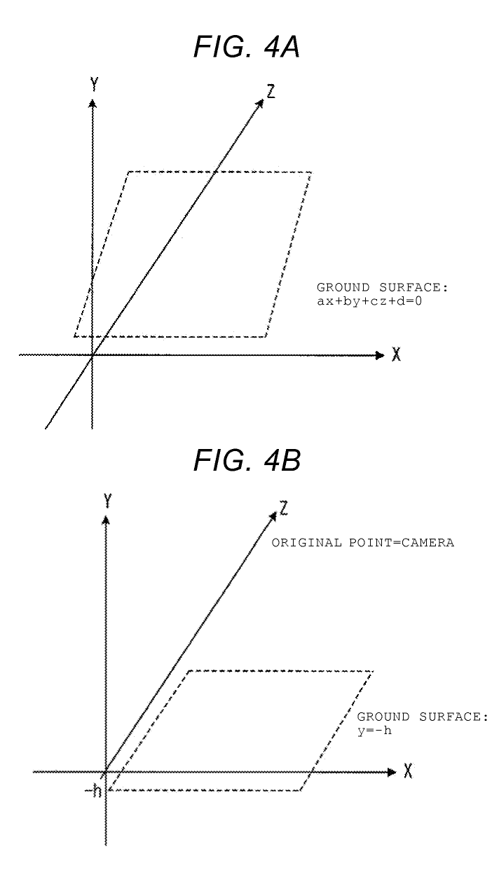

Next, image processing of the image processing apparatus 100 will be described with reference to FIG. 3 to FIG. 21. FIG. 3 is a flowchart of image processing carried out by the image processing apparatus 100. FIGS. 4A and 4B to FIG. 21 are used to describe each step of the image processing.

As illustrated in FIG. 3, the image sensor information is acquired by the image sensor 11 (STEP S1). Also, the distance sensor information is acquired by the distance image sensor 12 (STEP S2). The acquired image sensor information is stored as a camera image in the image information region 21 (STEP S3). The acquired distance sensor information is stored as a distance information in the distance information region 22 (STEP S4).

The restoring section 32 generates three-dimensional information (three-dimensional data) that includes three-dimensional coordinates (x, y, z) of a point group (point cloud) based on the camera image and the distance information (STEP S5).

The acquiring section 33 then performs identification of a ground surface (STEP S6), extraction of ground surface data (STEP S7), and extraction of obstacle data (STEP S8).

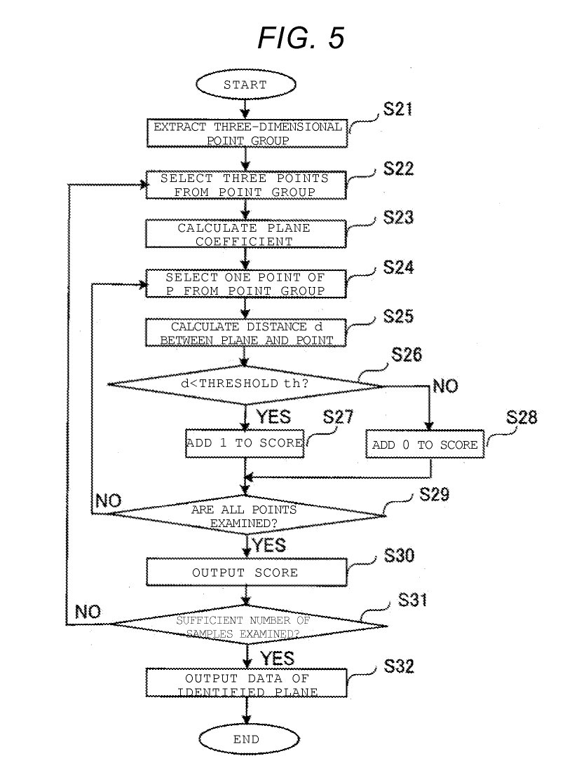

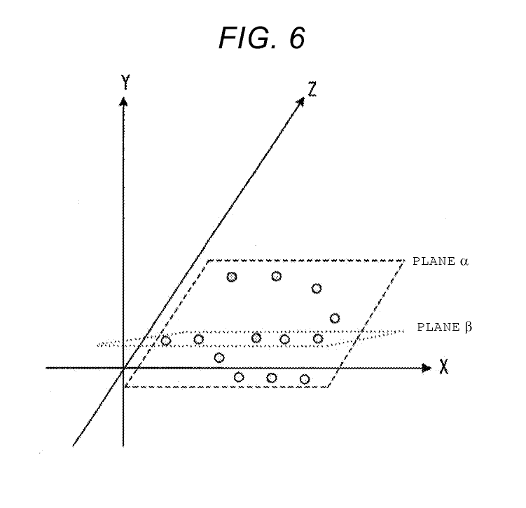

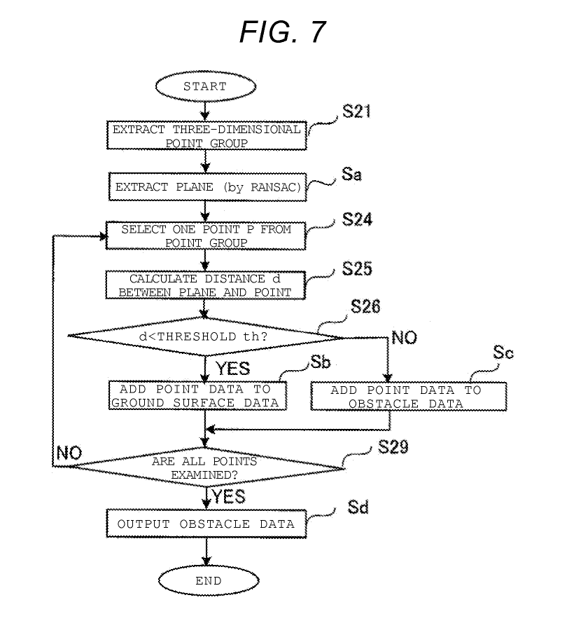

Next, the identification of the ground surface in STEP S6 will be described in detail with reference to FIGS. 4A and 4B and FIG. 5. The extraction of ground surface data in STEP S7 and the extraction of the obstacle data in STEP S8 will be described in detail with reference to FIG. 6 and FIG. 7.

FIG. 4A illustrates identification of the ground surface when the image acquiring unit 1 is arbitrarily oriented with respect to the ground surface. FIG. 4B illustrates identification of the ground surface when an image capturing angle of the image acquiring unit 1 is parallel to the ground surface. FIG. 5 is a flowchart of processing to identify the ground surface and the extraction of the ground surface using RANSAC (random sample consensus). FIG. 6 illustrates the extraction of the ground surface using the RANSAC. FIG. 7 is a flowchart of processing to extract obstacle data.

The acquiring section 33 extracts data corresponding to the ground surface from the acquired three-dimensional data and outputs the remaining data as obstacle data.

As described in FIG. 4A, generally in a three-dimensional space, when a three-dimensional coordinate is expressed as (x, y, z), the ground surface may be expressed as a plane equation ax+by+cz+d=0.

When the image acquiring unit 1 is fixed to a vehicle body or the like, coefficients a, b, c, and d are specifically determined provided that the relationship between the position and angle of the image acquiring unit 1 and the ground surface is always the same. For example, as illustrated in FIG. 4B, when the image acquiring unit 1 is parallel to the ground surface and the distance from the ground surface is set as h, the correlations may be simply expressed as y=−h (a=0, b=1, c=0, d=h).

When the position and angle of the image acquiring unit 1 change (including when the change is extensive due to the vibration of the vehicle or the like), the plane corresponding to the ground surface may need to be identified for each frame based on the acquired three-dimensional data. In this case, as it may be assumed that one of the plane equations including many points is the ground surface, the corresponding plane equation is identified. Since the three-dimensional data includes many points corresponding to obstacles other than the points corresponding to the ground surface, it may not be able to easily extract the ground surface by a simple least squares method. In this case, it is preferable to use the random sample consensus (RANSAC) algorithm. In the present embodiment, the plane is extracted by using the RANSAC.

In FIG. 5, first, a group of three-dimensional points is extracted using the plane extraction method employing the RANSAC (STEP S21). From the group of points, three points are selected randomly (STEP S22). The coefficients (a, b, c, d) of a plane equation that includes the three points, which is a plane A, are calculated (STEP S23). From the group of the three-dimensional points, a point P is selected (STEP S24). A distance d between the plane A and the point P is calculated (STEP S25).

Then, it is determined whether than the distance d is smaller than a threshold th (STEP S26). When the distance d is smaller than the threshold th, 1 is added to a score (STEP S27). When the distance d is equal to or greater than the threshold th, 0 (zero) is added to a score (STEP S28).

Then, it is determined whether the processing with respect to all three-dimensional points has been performed (STEP S29). If the processing for all points has not been performed, the process returns to STEP S24. If the processing for all points has been performed, the score is output (STEP S30). If the score is the higher than the previous ones, the highest score is updated.

Then, it is determined whether the number of sample planes is sufficient (STEP S31) . If the number of the sample planes is not sufficient, the process returns to STEP S22. If the number of the sample planes is sufficient, a plane equation of a plane A with the highest score is output (STEP S32).

Since, in many cases, the ground surface covers a large part of the image captured by the image acquiring unit 1, it is possible to identify the ground surface through the RANSAC method. When a wall surface of a building or the like is identified as the ground surface, it may be easily determined that the identification is incorrect based on a positional mismatch between the plane and the image acquiring unit 1 (the ground surface can be assumed to be not perpendicular to the image capturing angle of the image acquiring unit 1). For this reason, it is possible to identify the ground surface by performing the above-described process using the RANSAC method again or the like after removing the plane data incorrectly identified as the ground surface.

FIG. 6 illustrates a case where planes α and β are examined to identify the ground surface through the RANSAC method. Here, the plane α has a greater number of points, while the plane β has a smaller number of points. Although only two planes are illustrated in FIG. 6, a large number of planes are examined and a plane that is most likely to be the ground plane is selected.

The acquiring section 33 uses the plane equation that represents the ground surface to determine whether a point P is in the ground surface. In this case, it is determined that the point P is in the ground surface when the coordinate of the point P satisfies the plane equation or the distance from the plane to the point P is within a certain value. More specifically, the distance h from the plane to the point P may be expressed as:

h=|ax+by+cz+d|/(a²+b²+c²)^{1/2} (1)

When the distance h is less than the certain threshold th (h<=th), the point P is considered to be in the plane. According to the above, when the point P is in the ground surface, the coordinate of the point P is output as ground surface data. When the point P is not in the ground surface, the coordinate of the point P is output as obstacle data.

As illustrated in FIG. 7, in a process of the obstacle data extraction, the plane extraction is performed using the RANSAC (STEP Sa) after extracting the group of the three-dimensional points (STEP S21). After the plane extraction, STEP S24 to STEP S26, which are the same as STEP S24 to STEP S26 illustrated in FIG. 5, are carried out.

When the distance d is smaller than the threshold th, the coordinate of the point P is added to the ground surface data (STEP Sb). When the distance d is equal to or greater than the threshold th, the coordinate of the point P is added to the obstacle data (STEP Sc).

Then, it is determined whether or not the processing is performed with respect to all three-dimensional points (STEP S29) . If it is determined that the processing is not performed for all points, the process returns to STEP S24. If it is determined that the processing is performed for all points, the obstacle data is output (STEP Sd).

The acquiring section 33 calculates the distance to the plane from all three-dimensional points extracted, and determines whether each of the point is in the plane. However, as this calculation can be independently performed for every point, it is possible to perform parallel processing at the same time. Therefore, it is possible to accelerate the processing by using a multi-core processor or a general-purpose computing on graphics processing unit (GPGPU).

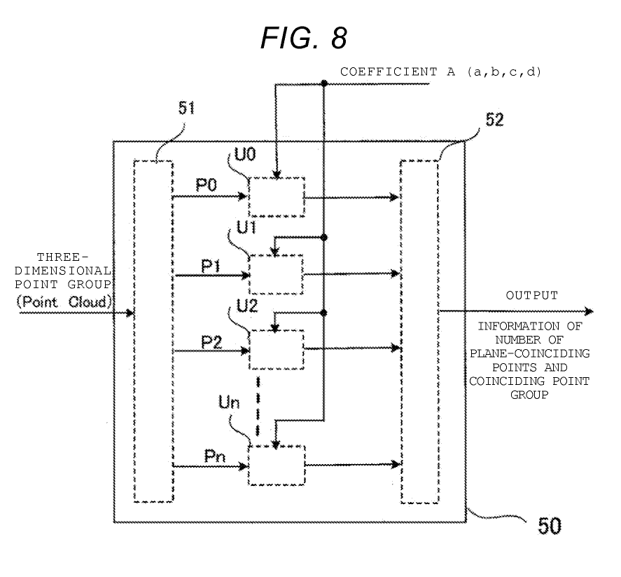

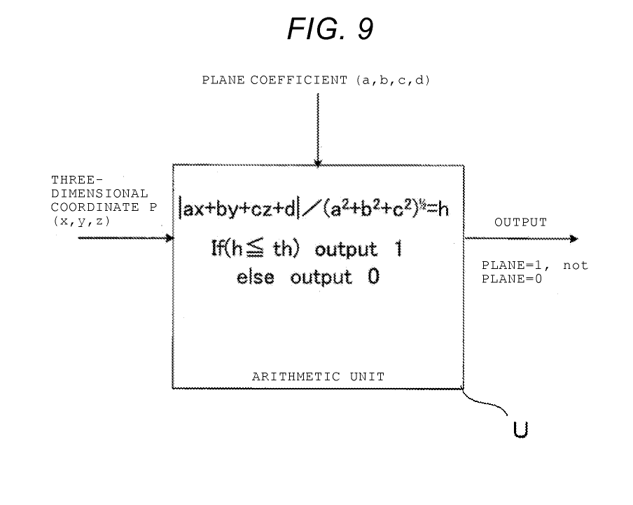

Next, a specific circuit configuration of the acquiring section 33 that determines whether a point P is in the ground surface (plane coincidence calculation processing) will be described with reference to FIGS. 8 and 9. FIG. 8 is a block diagram of a plane coincidence calculation processing unit of the acquiring section 33. FIG. 9 is a block diagram of an arithmetic unit of the plane coincidence calculation processing unit.

As illustrated in FIG. 8, a plane coincidence calculation processing unit 50 includes a point group data dividing unit 51, arithmetic units U0 to Un, and a result combining unit 52.

The point group data dividing unit 51 receives data of three-dimensional point group (point cloud), divides the data into a plurality of point data represented by three-dimensional coordinate Pi (x, y, z) (i=0 to n), and sends the three-dimensional coordinate Pi (x, y, z) to each of the arithmetic units U0 to Un.

As illustrated in FIG. 9, each of the arithmetic units U0 to Un (here, representatively illustrated as an arithmetic unit U) performs arithmetic processing, using the input three-dimensional coordinate P (x, y, z), the coefficients (a, b, c, d), and the threshold th. Each of the arithmetic units U outputs 1 when the distance from the corresponding point to the plane is within the threshold th and output 0 (zero) when the distance from the corresponding point to the plane is greater than the threshold th.

The result combining unit 52 receives data output from each of the arithmetic units U0 to Un. The result combining unit 52 combines the received data with each other and forms a unit of data (for example, 0/1 is arranged one by one from 0 to n to form an n-bit data). In this case, the number of each digit of the n-bit data may be added, and the sum may be output as a score. Using the score, each point in the point group is determined to belong to the ground surface or obstacles.

The plane coincidence calculation processing unit 50 includes a plurality (n) of arithmetic units U arranged in parallel. Compared to when a single arithmetic device for general use conducts arithmetic processing for all points, the identification of the ground surface and the extraction of obstacles may be accelerated. As a result, power consumption for the processing may be decreased.

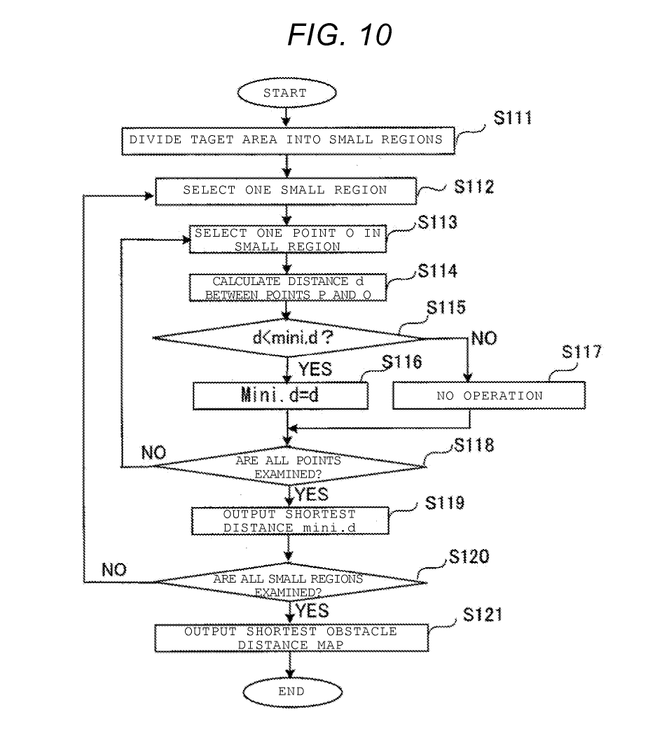

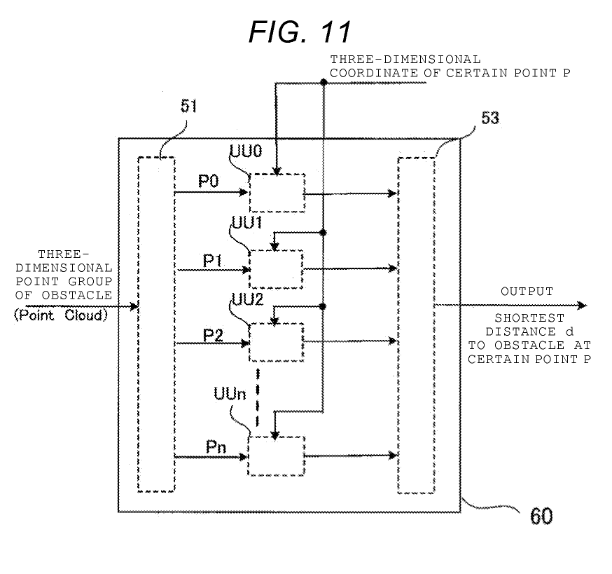

Next, the distance calculating section 34 performs obstacle distance calculation (STEP S9 (refer to FIG. 3)). The obstacle distance calculation will be described in detail with reference to FIG. 10 to FIG. 13. FIG. 10 is a flowchart of processing to calculate the distance to the obstacles. FIG. 11 is a block diagram of a shortest-distance calculation processing unit of the distance calculating section 34. FIG. is a block diagram of an arithmetic unit of the shortest-distance calculation processing unit.

As illustrated in FIG. 10, in the obstacle distance calculation, an image capturing area of the image acquiring unit 1 in which obstacles around a moving object (for example, a vehicle driven by a driver or the like) are to be recognized is divided into small regions (grid map) (STEP S111). Then, one of the small regions (grid) is selected and a representative point P of the small region (for example, a center position of the small region) is selected (STEP S112). From the point group of the obstacle data, a point 0 is selected (STEP S113).

A distance d between a point P and the point 0 is calculated (STEP S114). For example, when the position information is three-dimensional, a distance d between the point P (x0, y0, z0) and an obstacle 0 (x1, y1, z1) may be expressed as:

d=f{(x0−x1)²+(y0−y1)+(z0−z1)²]^{1/2} (2)

It is determined whether the distance d is less than a shortest distance mini.d (STEP S115). If the distance d is less than the shortest distance mini.d, the distance d is set as the shortest distance mini.d (STEP S116). If the distance d is not less than the shortest distance mini.d, the distance d is ignored (STEP S117). Then, it is determined whether the processing with respect to all points from the point group of the obstacle data has been completed (STEP S118). If the processing has not been completed, the process returns to STEP 5113. If the processing has been completed, the shortest distance mini.d to the obstacles is output (STEP S119).

Then, it is determined whether the processing with respect to all small regions has been completed (STEP S120). If the processing has not been completed, the process returns to STEP S112. If the processing has been completed, a map of obstacles that are closest to the image acquiring unit 1 in each small region is output (STEP S121).

In the above step, the following is used as a pseudo code when the map is generated.

for (float x0=min_x; x0<max_x; x0+=dx) {
for (float y0=min_y; y0<max_y; y0+=dy) {
for (float z0=min_z; z0<max_z; z0+=dz) {
for (int i=0; i<obstacles->size( ); i++) {
Point P(x0, y0, z0):
Point O = obstacles->at(i);
float dist = sqrt((P.x − O.x) ²) + (P.y − O.y) ²) +
(P.z − 0.z)2);
if (dist < min_dist) min_dist = dist;
}
map(x,y, z) = min_dist;
}}}

In the above calculation, the number of calculation increases as the number of the divided small regions increases and as the number of obstacle points increases. However, the calculation can be accelerated by using an exclusive hardware and parallel calculation technique including GPGPU or the like, because the calculation is simple. Therefore, it is preferable to use these techniques to accelerate the calculation.

As illustrated in FIG. 11, a shortest-distance calculation processing unit 60, which is included in the distance calculating section 34, includes the point group data dividing unit 51, arithmetic units UU0 to UUn, and a shortest-distance selecting unit 53.

The point group data dividing unit 51 receives data of the three-dimensional point group (point cloud) corresponding to obstacles, divides the data into a plurality of point data, each corresponding to a three-dimensional coordinate Pi (x, y, z) (i=0 to n), and sends the divided data to the arithmetic units UU0 to UUn, respectively.

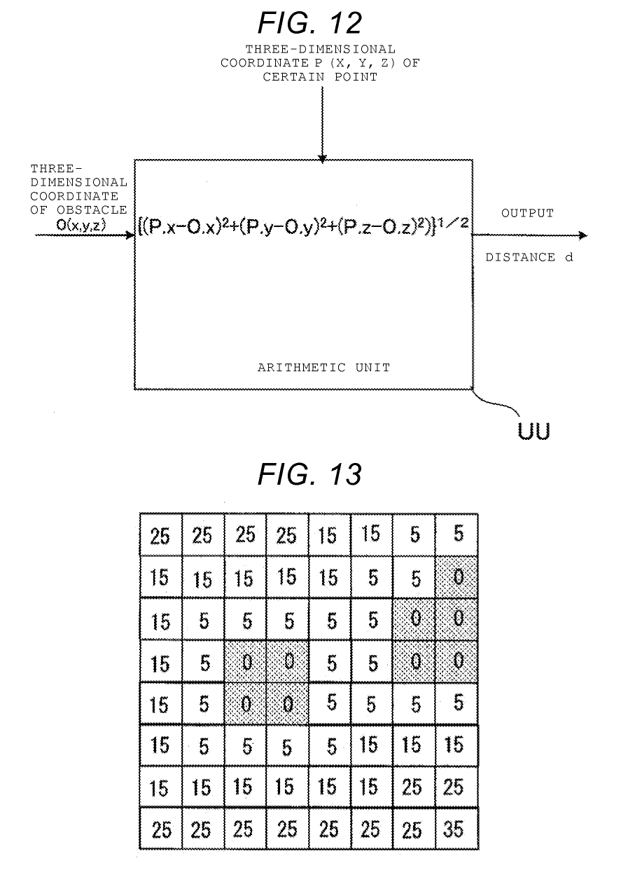

As illustrated in FIG. 12, each of arithmetic units UU0 to UUn (here, representatively illustrated as an arithmetic unit UU) performs arithmetic processing using the three-dimensional coordinate O (x, y, z) of the obstacles and the three-dimensional coordinate P (x, y, z) of the point P. The arithmetic unit UU outputs the information of the distance d.

The shortest-distance selecting unit 53 receives the information of the distance d output from each of the arithmetic units UU0 to UUn. The shortest-distance selecting unit 53 selects the shortest distance to the obstacles at the point P.

The shortest-distance calculation processing unit 60 is capable of calculating the shortest distance to the obstacles at the point P quickly.

The shortest-distance calculation processing unit 60 calculates the shortest distance to the obstacles with respect to each of the small regions of the area in which the obstacles are to be recognized while the point P is moving (while changing the coordinate of the point P) by using the above-described circuitry.

Next, the distance calculating section 34 generates an obstacle distance map with the obtained shortest distances to obstacles as a representative value of each small region (STEP S10 (refer to FIG. 3)). In FIG. 13, an example of the obstacle distance map generated by the distance calculating section 34 is illustrated. Here, for example, one small region is 10 cm×10 cm and the unit of the values in FIG. 13 is cm. As shown, obstacles (the distance is 0 (zero) cm) are present at nine points among 8×8 points.

As described above, it is preferable that the arithmetic processing in the acquiring section 33 and the distance calculating section 34 are performed by an exclusive hardware. However, such arithmetic processing requires a plurality of calculating circuits including a plurality of multipliers or the like. For this reason, considering the overall balance of the system including reusability in other calculating processing, implementation area, power efficiency, or the like, the arithmetic processing may be performed by software using a digital signal processor (DSP) or a graphics processing unit (GPU).

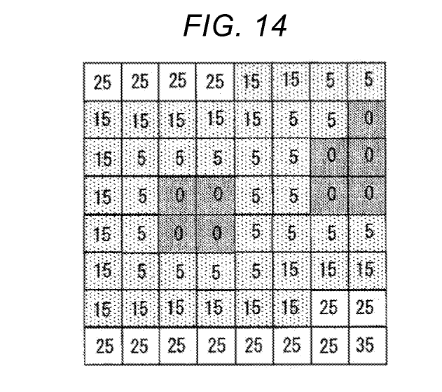

Next, the visualization processing section 35 performs visualization processing (STEP S11 (refer to FIG. 3)) and generates a visualized image (STEP S12 (refer to FIG. 3)). The processing of the visualization processing section 35 will be described with reference from FIG. 14 to FIG. 21.

The visualization processing section 35 generates an isoline map based on the obtained obstacle distance map. FIG. 14 is an isoline map indicating the distance to the obstacles in each of the small regions. In FIG. 14, the small regions of which value is within a certain range is displayed. Here, the small regions of which value is shorter than 25 cm are displayed. Further, the small regions may be indicated by being colored. When the width of a moving object is set as D, the moving object may contact obstacles within a distance D/2. Therefore, when coloring is performed based on the values, the possibility of the contact can be more easily recognized. In an above example, when a 50 cm-long moving object passes through the recognition area, the moving object may contact the obstacle.

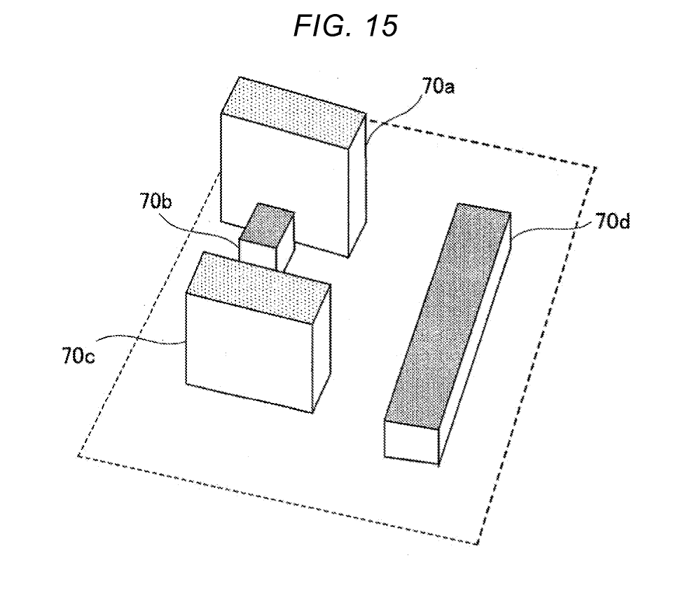

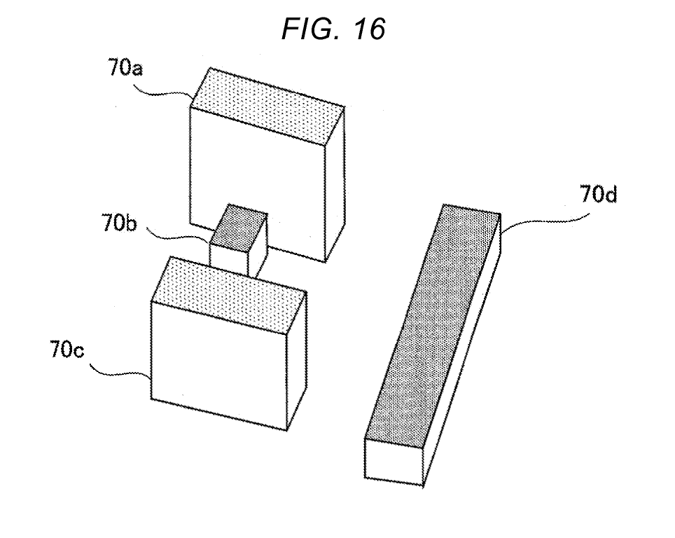

The visualization processing section 35 may be also applied to three-dimensional data. FIG. 15 is a perspective view of a three-dimensional image. In FIG. 15, for example, obstacles 70a to 70d inside a certain area are recognized and displayed as a three-dimensional image. In addition, FIG. 16 illustrates a three-dimensional image of obstacles.

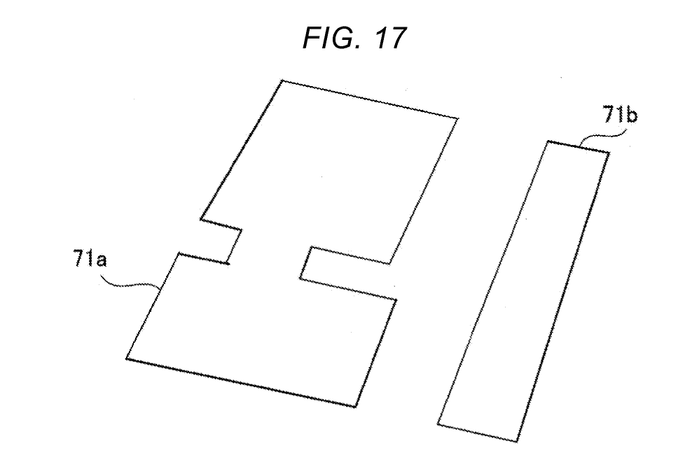

FIG. 17 illustrates an example of a visualized obstacle distance map. As illustrated in FIG. 17, an area in which distance to the obstacles 70a to 70c is shorter than a predetermined distance (for example, 25 cm) is displayed as a region 71a, and an area in which distance to the obstacles 70d is shorter than a predetermined distance is displayed as a region 71b.

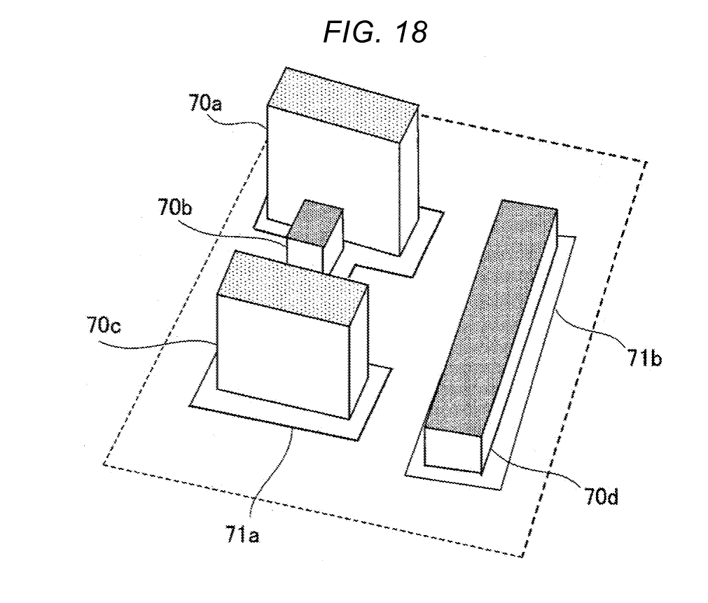

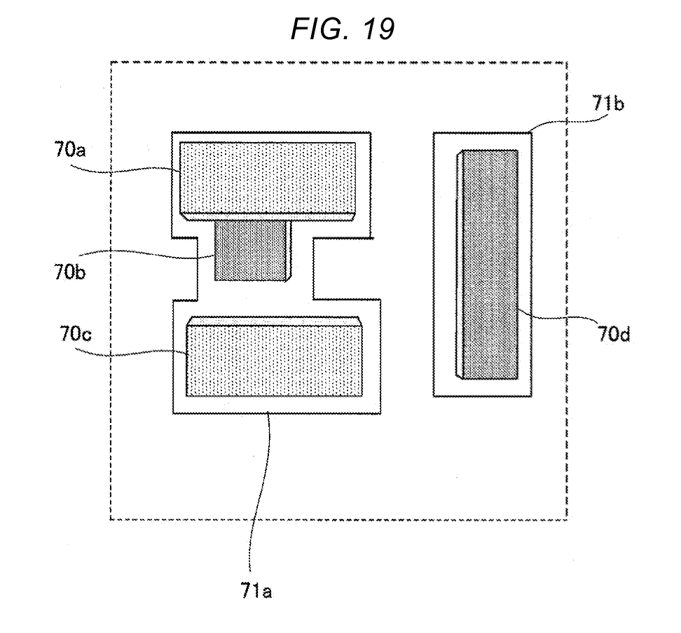

FIG. 18 illustrates an example of a combined three-dimensional image of the obstacles 70a-70d in FIG. 15 and the regions 71a-71b in FIG. 17. FIG. 19 illustrating the combined image viewed from a point right above.

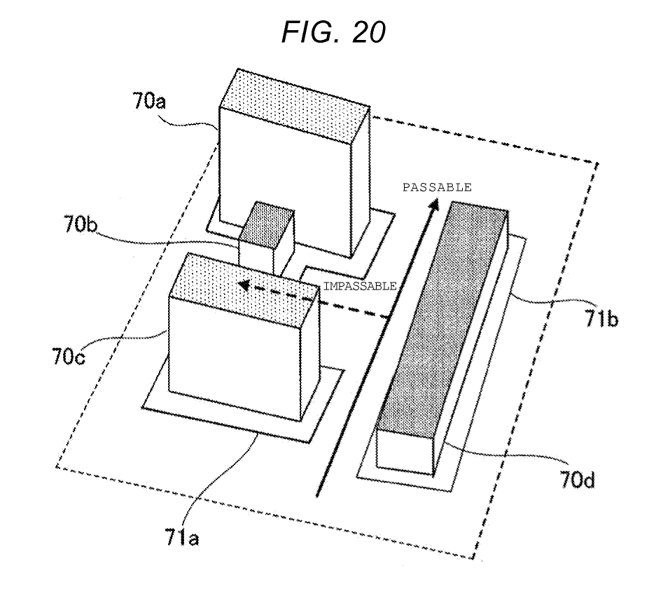

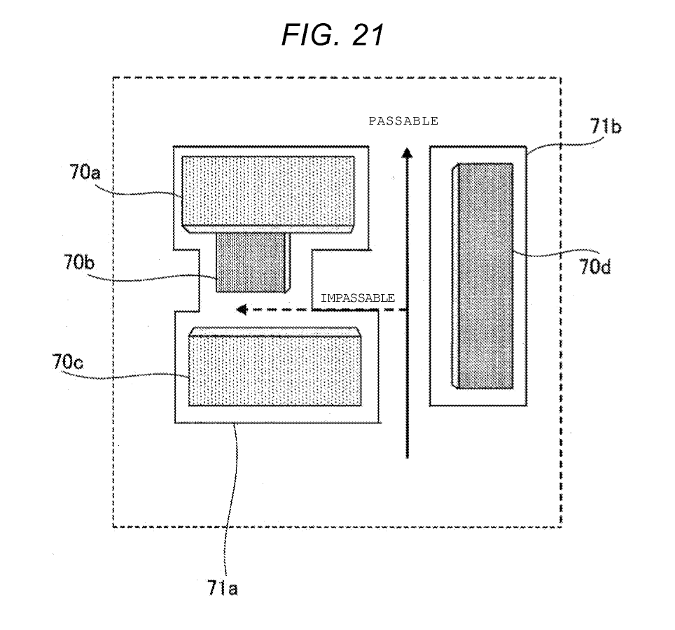

The obstacle determining unit 300 determines whether a moving object (vehicles or people) is capable of passing between the obstacles without contact. When the width of a moving object is set as D, the moving object may contact obstacles located within a distance D/2. FIG. 20 illustrates a passable route and an impassable route. FIG. 21 illustrates the passable route and the impassable route from a point right above. As illustrated in FIGS. 20 and 21, the passable and impassable routes are displayed.

For example, when the width of a vehicle, which is a moving object, is 180 cm, and 90 cm, which is the half of the value, is set in the visualization processing section 35, a user may recognize whether the moving object may pass between the obstacles. In addition, if the value is set in the obstacle determining unit 300, a driver may be able to recognize whether a driver may pass between the obstacles.

As described above, in the image processing apparatus and the drive assist system using the same, the image acquiring unit 1, the memory unit 2, and the image processing unit 3 are included in the image processing apparatus 100. The image acquiring unit 1 includes an image sensor 11 and a distance image sensor 12. The memory unit 2 includes an image information region 21, a distance information region 22, an intermediate image region 23, an obstacle distance map region 24, and a visualized image region 25. The image processing unit 3 includes the filter section 31, the restoring section 32, the acquiring section 33, the distance calculating section 34, and the visualization processing section 35. The drive assist system is mounted on the vehicle 500. The drive assist system includes the memory unit 2, the image processing unit 3, the image sensor 11, the distance image sensor 12, the display unit 200, and the obstacle determining unit 300. The drive assist system visualizes the obstacle information.

With such a drive assist system, a driver is capable of predicting a vehicle contacting against the obstacle in advance. The driver is capable of driving safely since the driver is capable of selecting the passable route in advance (before reaching an obstacle).

In addition, in the present embodiment, a vehicle driven by the driver is set as the moving object. However, the moving object may be a radio-controlled moving object, an airplane, people or animals in motion, a sailing ship, or the like.

In addition, the image sensor 11 is disposed on the image acquiring unit 1. However, a series of processing may be performed only with three-dimensional shape information without using visualized information. In this case, the image sensor 11 may be omitted and only the distance image sensor 12 may be used.

In addition, to acquire the three-dimensional information, a one-point range finding type TOF sensor or line-type TOF sensor may be used. In this case, the obtained information is point or line information, not an image. However, such information can be considered as image information and such a sensor can be included in the image acquiring unit 1.

### Second Embodiment

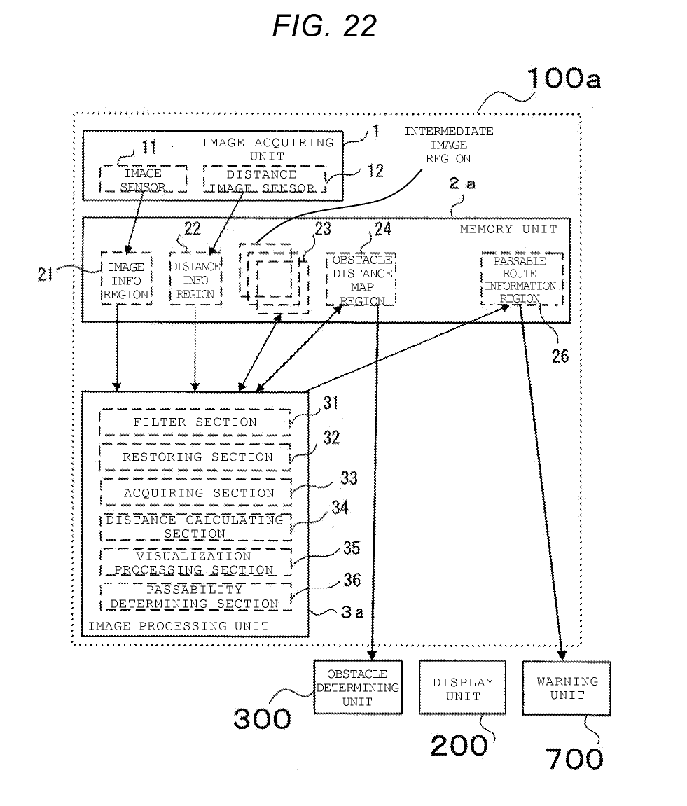

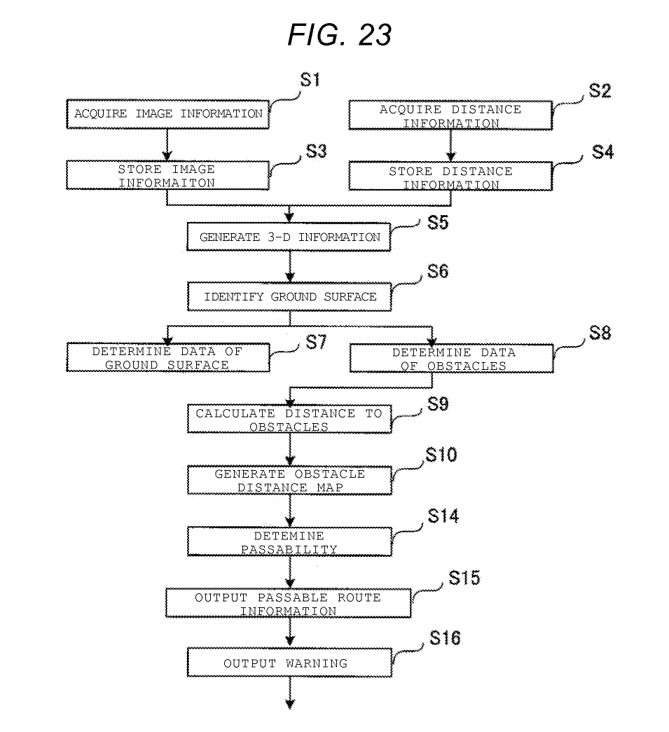

Next, an image processing apparatus according to a second embodiment will be described with reference to the drawings. FIG. 22 illustrates a configuration of an image processing apparatus 100a according to the second embodiment. FIG. 23 is a flowchart of image processing carried out by the image processing apparatus 100a. In the present embodiment, a passable-route information region 26 is included in a memory unit 2a.

Hereinafter, with regard to the same component as that in the first embodiment, the same symbol will be used and detailed description thereof will be omitted, and only the different component will be described.

As illustrated in FIG. 22, the image processing apparatus 100a includes an image acquiring unit 1, the memory unit 2a, and an image processing unit 3a. The image processing apparatus 100a is able to detect the distance to an obstacle with high accuracy and predict a vehicle contacting the obstacle in advance.

The memory unit 2a includes an image information region 21, a distance information region 22, an intermediate image region 23, an obstacle distance map region 24, and a passable route information region 26.

The image processing unit 3a includes a filter section 31, a restoring section 32, an acquiring section 33, a distance calculating section 34, and a passability determining section 36.

The passability determining section 36 combines an obstacle distance map generated by an image processing unit 3 and passable route information obtained from published map information or the like, and determines whether a route that the moving object is going to use is impassable due to an obstacle, based on the combined data.

The passability determining section 36 determines that a route is passable as illustrated in FIG. 23 (STEP S14) and outputs information of a passable route and an impassable route to the passable route information region 26 (STEP S15). The passable route information region 26 stores the information of the passable route and the impassable route. The passable route information region 26 also stores route information including car navigation information or the like.

A warning unit 700, for example, is disposed on the right-front portion of a vehicle (refer to FIG. 2). The warning unit 700 outputs a warning (alert signal) (STEP S16).

More specifically, the warning unit 700 outputs the warning to a driver based on the passable route information stored in the passable route information region 26 when, for example, the route set by a car navigation or the like is impassable. The warning, for example, may be displayed on a car navigation screen or a cockpit, and in addition a sound (or a voice) may be generated.

As described above, in the image processing apparatus and the drive assist system using the same, the image acquiring unit 1, the memory unit 2a, and the image processing unit 3a are included in the image processing apparatus 100a. The image acquiring unit 1 includes an image sensor 11 and a distance image sensor 12. The memory unit 2a includes an image information region 21, a distance information region 22, an intermediate image region 23, an obstacle distance map region 24, and a passable route information region 26. The image processing unit 3a includes a filter section 31, a restoring section 32, an acquiring section 33, a distance calculating section 34, a visualization processing section 35, and a passability determining section 36. The drive assist system, for example, includes the memory unit 2, the image processing unit 3, the image sensor 11, the distance image sensor 12, the display unit 200, the obstacle determining unit 300, and the warning unit 700. The drive assist system warns a driver of an impassable route.

As a result, in the present embodiment, the same effect as in the first embodiment may be obtained.

### Third Embodiment

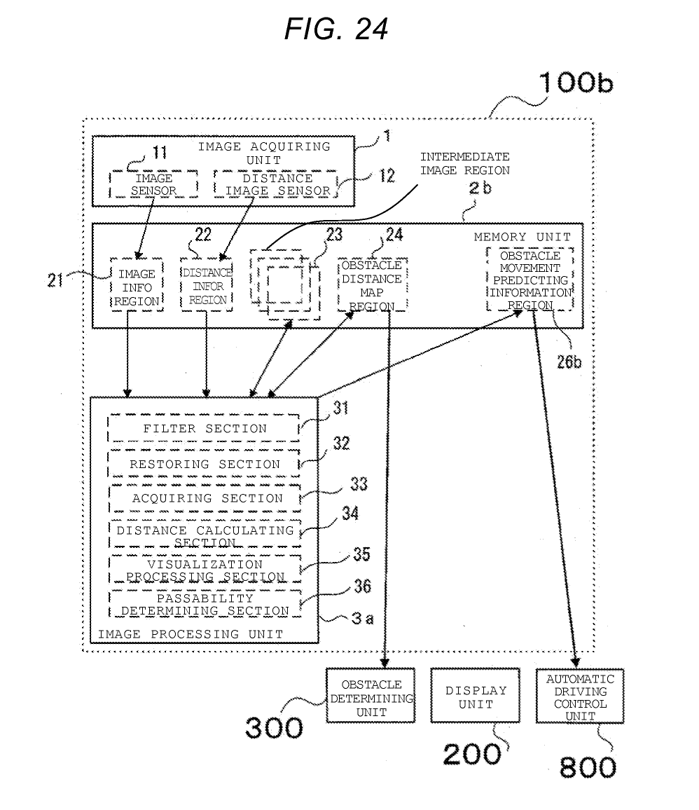

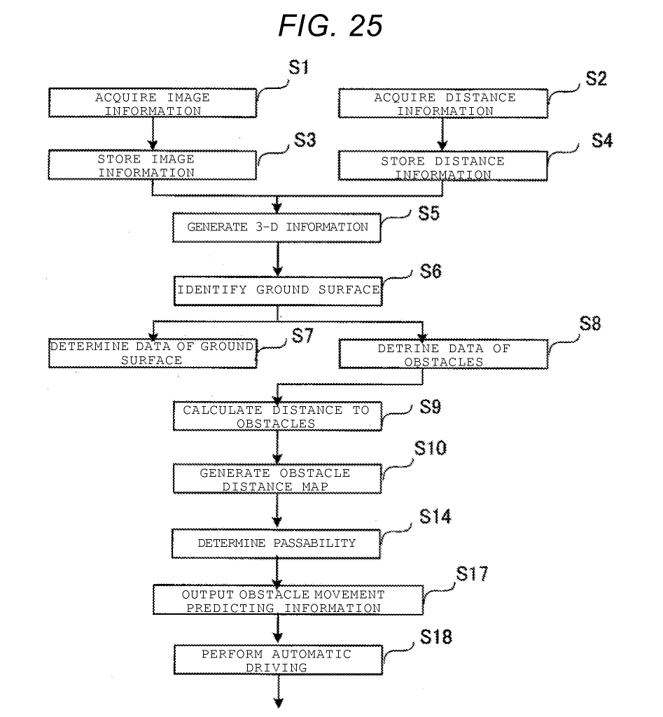

Next, an image processing apparatus according to the third embodiment will be described with reference to the drawings. FIG. 24 illustrates a configuration of an image processing apparatus 100b according to the third embodiment. FIG. 25 is a flowchart of image processing carried out by the image processing apparatus 100b. In the present embodiment, automatic driving control using a drive assist system is performed.

Hereinafter, with regard to the same component as that in the first embodiment, the same symbol will be used and detailed description thereof will be omitted, and only the different component will be described.

As illustrated in FIG. 24, the image processing apparatus 100b includes an image acquiring unit 1, a memory unit 2b, and an image processing unit 3a.

The memory unit 2b includes an image information region 21, a distance information region 22, an intermediate image region 23, an obstacle distance map region 24, and a passable route information region 26a.

An obstacle movement predicting information region 26b stores passable route information and impassable route information output from the passability determining section 36, and the information indicating whether an obstacle is a still object or a moving object. If the obstacle is a moving object, information including the proceeding direction, the proceeding speed thereof, or the like is also stored. The information including the proceeding direction, the proceeding speed, or the like is calculated using the image acquiring unit 1 and the image processing unit 3a.

The obstacle movement predicting information region 26b outputs the obstacle movement prediction information to an automatic driving controlling unit 800 (STEP S17 (refer to FIG. 25)).

The automatic driving controlling unit 800 additionally determines whether an obstacle moves (whether the obstacle disappears) based on the obtained passable and impassable routes. For example, if an obstacle does not move for a long period of time, a route along which the vehicle makes a detour and reaches a destination is selected and automatic driving is performed (STEP S18 (refer to FIG. 25)).

As illustrated above, in the image processing apparatus and the drive assist system using the same, the image acquiring unit 1, the memory unit 2b, and the image processing unit 3a are provided at the image processing apparatus 100b. The memory unit 2b includes an image information region 21, a distance information region 22, an intermediate image region 23, an obstacle distance map region 24, and a passable route information region 26a. The drive assist system, for example, includes the memory unit 2b, the image processing unit 3a, the image sensor 11, the distance image sensor 12, the display unit 200, the obstacle determining unit 300, and the automatic driving controlling unit 800. The drive assist system controls automatic driving of a vehicle.

As a result, in the present embodiment, the same effect as in the first embodiment is obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Exemplary embodiments herein are considered as including the configurations that are described in the following appendix.

### Appendix 1

A drive assist system including an image sensor that acquires an image at the surroundings including obstacles, a distance image sensor that acquires information of a distance to the obstacle, a restoring unit that restores three-dimensional information from the obtained image or the distance information, an acquiring unit that acquires obstacle data from the three-dimensional information, a distance calculating unit that calculates an obstacle distance map regarding a moving object by calculating the shortest distance from a vehicle driven by a driver to the obstacle, a visualization processing unit that visualizes the obstacle distance map by using contour lines, and a display unit that displays the visualized images.

### Appendix 2

A drive assist system including an image sensor that acquires an image at the surroundings including obstacles, a distance image sensor that acquires the distance to the obstacle, a restoring unit that restores three-dimensional information from the obtained image or the distance information, an acquiring unit that acquires obstacle data from the three-dimensional information, a distance calculating unit that calculates an obstacle distance map regarding a moving object by calculating the shortest distance from a vehicle driven by a driver to the obstacle, and an obstacle determining device that determines the possibility of the vehicle contacting against the obstacle in advance.

### Appendix 3

A drive assist system including an image sensor that acquires an image at the surroundings including obstacles, a distance image sensor that acquires the distance to the obstacle, a restoring unit that restores three-dimensional information from the obtained image or the distance information, an acquiring unit that acquires obstacle data from the three-dimensional information, a distance calculating unit that calculates an obstacle distance map regarding a moving object by calculating the shortest distance from a vehicle driven by a driver to the obstacle, a passability determining unit that determines passable and impassable routes, and a warning unit that warns the driver based on passable route information calculated by the passability determining unit when the passing route becomes impassable.

### Appendix 4

A drive assist system including an image sensor that acquires an image at the surroundings including obstacles, a distance image sensor that acquires the distance to the obstacle, a restoring unit that restores three-dimensional information from the obtained image or the distance information, an acquiring unit that acquires obstacle data from the three-dimensional information, a distance calculating unit that calculates an obstacle distance map regarding a moving object by calculating the shortest distance from a vehicle driven by a driver to the obstacle, a passability determining unit that determines passable and impassable routes and determines whether the obstacle is a moving object, and an automatic driving control unit that performs automatic driving by additionally determining whether the obstacle changes across a long period of time based on the obtained passable and impassable routes, and, if the obstacle does not move for a long period of time, selecting a route in which the vehicle makes a detour and reaches a destination.

### Appendix 5

A drive assist system according to one of Appendix 1 to Appendix 4 in which the image sensor includes a camera that detects a visible area to detect a daytime image and a night vision camera that detects a near infrared area or a far-infrared area to detect a night image.

### Appendix 6

A drive assist system according to one of Appendix 1 to Appendix 4 in which the distance image sensor includes a time-of-flight (TOF) camera that may respond in both day and night or a plurality of cameras that may respond in both day and night.

What is claimed is:

1. A system for obstacle avoidance around a moving object, comprising:
an image capturing unit configured to capture images in a moving direction of the object;
a processing unit configured to generate three-dimensional data based on the captured images, determine positions of obstacles in a three-dimensional space according to the three-dimensional data, and generate an image including marks indicating a region proximate to the obstacles; and
a display unit configured to display the generated image.

2. The system according to claim 1, wherein
the processing unit determines the positions of the obstacles, by determining a ground surface in the three-dimensional space and extracting positions in the three-dimensional space not belonging to the ground surface.

3. The system according to claim 1, wherein
the processing unit generates the image, by determining positions in the three-dimensional space that are within a predetermined distance from the obstacles, and
the region is within the predetermined distance from the obstacles.

4. The system according to claim 3, wherein
the processing unit determines the positions in the three-dimensional space that are within the predetermined distance, by dividing the positions in the three dimensional space into a plurality of small regions, and calculating a distance from the obstacles with respect to each small region.

5. The system according to claim 1, further comprising:
a calculating unit configured to determine whether or not the object is able to move through a space between the obstacles based on the generated image, wherein
the display unit is further configured to indicate a determination result of the calculating unit.

6. The system according to claim 5, wherein
whether or not the object is able to move through the space is determined based on a width of the space and a width of the object.

7. The system according to claim 5, further comprising:
a warning generating unit configured to generate a warning based on the determination result of the calculating unit.

8. The system according to claim 5, further comprising:
a control unit configured to cause the object to move, such that the object does not contact the obstacles.

9. An image processing device having a processing unit configured to perform steps of:
receiving images in a direction in which an object is moving;
generating three-dimensional data based on the received images;
determining positions of the obstacles in a three-dimensional space according to the three-dimensional data; and
generating an image including marks indicating a region proximate to the obstacles.

10. The image processing device according to claim 9, wherein
the positions of the obstacles are determined by determining a ground surface in the three-dimensional space and extracting positions in the three-dimensional space not belonging to the ground surface.

11. The image processing device according to claim 9, wherein
the image is generated by determining positions in the three-dimensional space that are within a predetermined distance from the obstacles, and
the region is within the predetermined distance from the obstacles.

12. The image processing device according to claim 9, wherein
the positions in the three-dimensional space that are within the predetermined distance are determined by dividing the positions in the three dimensional space into a plurality of small regions, and calculating a distance from the obstacles with respect to each small region.

13. The image processing device according to claim 9, wherein the steps further including:
determining whether or not the object is able to move through a space between the obstacles based on the generated image.

14. The image processing device according to claim 13, wherein
whether or not the object is able to move through the space is determined based on a width of the space and a width of the object.

15. An image processing method, comprising:
receiving images in a direction in which an object is moving;
generating three-dimensional data based on the received images;
determining positions of the obstacles in a three-dimensional space according to the three-dimensional data; and
generating an image including marks indicating a region proximate to the obstacles.

16. The method according to claim 15, wherein
the positions of the obstacles are determined by determining a ground surface in the three-dimensional space and extracting positions in the three-dimensional space not belonging to the ground surface.

17. The method according to claim 15, wherein
the image is generated by determining positions in the three-dimensional space that are within a predetermined distance from the obstacles, and
the region is within the predetermined distance from the obstacles.

18. The method according to claim 15, wherein
the positions in the three-dimensional space that are within the predetermined distance are determined by dividing the positions in the three dimensional space into a plurality of small regions, and calculating a distance from the obstacles with respect to each small region.

19. The method according to claim 15, further comprising:
determining whether or not the object is able to move through a space between the obstacles based on the generated image.

20. The method according to claim 19, wherein
whether or not the object is able to move through the space is determined based on a width of the space and a width of the object.
